(19) United States
(12) Patent Application Publication
(10) Pub. No.: US 2026/0251580 A1
(43) Pub. Date: Aug. 27, 2026

(54) INSPECTION SYSTEM AND METHOD FOR PHARMACEUTICAL VIALS

(71) Applicant: MECTRON ENGINEERING COMPANY, INC., Saline, MI (US)

(72) Inventors: Mark L. HANNA, Ann Arbor, MI (US); Andrew HANNA, Saline, MI (US)

(73) Assignee: MECTRON ENGINEERING COMPANY, INC., Saline, MI (US)

(21) Appl. No.: 19/061,590

(22) Filed: Feb. 24, 2025

(51) Int. Cl. G01N 21/88; G01N 35/04; G01N 21/17

(52) U.S. Cl. CPC G01N 21/8851; G01N 35/04; G01N 2021/177; G01N 2021/8887; G01N 2035/0496; G01N 2201/04; G01N 2201/062

(57) ABSTRACT

An inspection system for automated video inspection for quality control processes. The inspection system is particularly adapted for rotationally symmetrical pharmaceutical vials including small arms ammunition vials. The system provides a first array of light sources oriented radially around the pharmaceutical vial path presenting zones of illumination on the pharmaceutical vial at discrete radial positions. A second illuminator is in the form of linear arrays of light emitting elements oriented along linear arrays. A camera oriented to observe images of light provided by the first and second arrays records video images of the pharmaceutical vials for use in resolving criteria of acceptable and unacceptable parts.

### FIELD OF THE INVENTION

This invention relates to a video parts inspection system for quality control applications and particularly to such a system adapted for the inspection of pharmaceutical vials containing a liquid or powder material.

### BACKGROUND

In serial production of mass-produced components, quality control systems are often used to assure high-quality final products. For example, in the production of pharmaceutical drugs contained in vials, it is desired to implement an automated inspection system which can identify defective vials or vials containing a liquid or powder which do not meet visual inspection criteria. For example, small vials of drugs, dietary supplements, vitamins or biological samples often require automated inspection to ensure that they are properly filled with a desired liquid or powder material. Also, for many types of pharmaceutical compounds it is important to assure that contaminant particles are not present in the liquid contained in the vials. In the case of a vial containing a powder material, a lack of homogeneity of the mixture may signify a contaminated fill. One approach toward providing quality control is the use of human inspectors which visually observe the vials as they move through an assembly line stream. In addition to the cost for implementing such a system, reliability of such inspection is a concern. Numerous approaches toward automating such inspection systems have been implemented. Such systems typically rely upon so-called machine vision systems in which the vials are illuminated in some manner and reflected or transmitted light images are evaluated by video cameras or linear detector arrays and associated data processing systems. Although such systems have been found to operate generally satisfactorily, they are frequently unable to resolve a more complete range of defects found in such components, limit throughput rate, can be costly to purchase and operate, and give rise to their own significant maintenance requirements. A particular concern for pharmaceutical vials containing a liquid is that the presence of particles mixed into the liquid is difficult to observe. In many instances, particles will tend to accumulate either at a bottom or upper portion of a vial due to density differences. This tenancy of particle separation and accumulation makes the presence of such particles often difficult to detect in an automated manner. Similarly, when vials containing powders are to be examined, containments may be hidden in the mixture. Accordingly, there is a need to provide improved inspection systems for such applications.

In accordance with the present invention an inspection system is provided using arrays of light sources such as LEDs arranged around a part inspection station. The light sources are arranged to essentially form stripes of light reflecting from and through the vial. Disruptions in the reflected images can reveal defects. In one implementation, a conveyor system is used to simultaneously traverse and rotate the vials through the inspection area to enable full coverage of the inspection process. The methodology of moving the vials to rotate them as they move axially into the test section causes suspended or accumulated particles in a liquid contained in the vials to be agitated and distributed within the liquid volume such that they can be detected. In this manner, the particles become visible and can be evaluated for automated inspection. In a similar manner, such rotational agitation of vials containing a powder will cause contaminants in the powder to be exposed for evaluation.

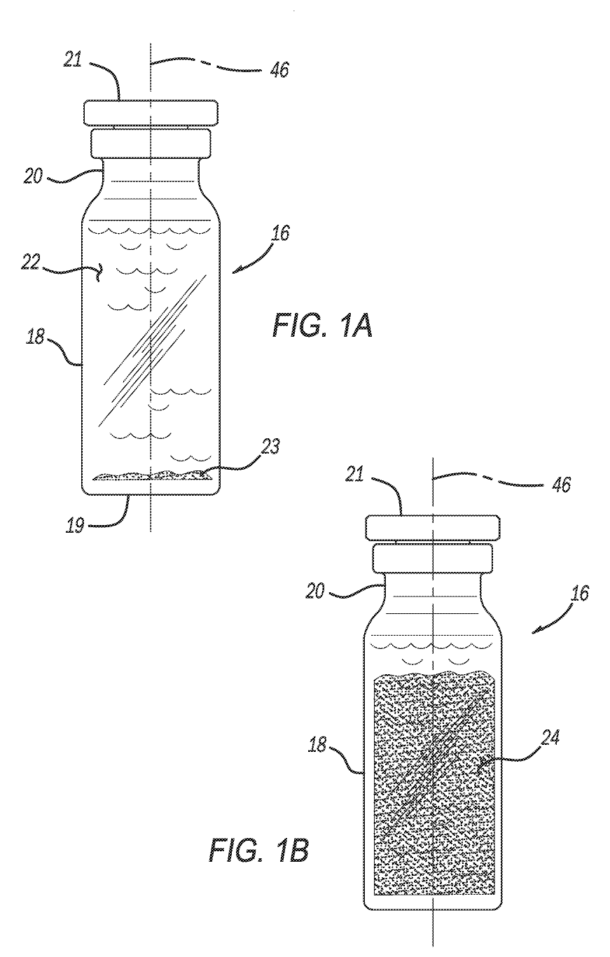

FIGS. 1A and 1B are a pictorial views of a pharmaceutical vial of a type suited for use with the inspection system in accordance with the present invention partially filled with a liquid in FIG. 1A and partially filled with a powder in FIG. 1B.

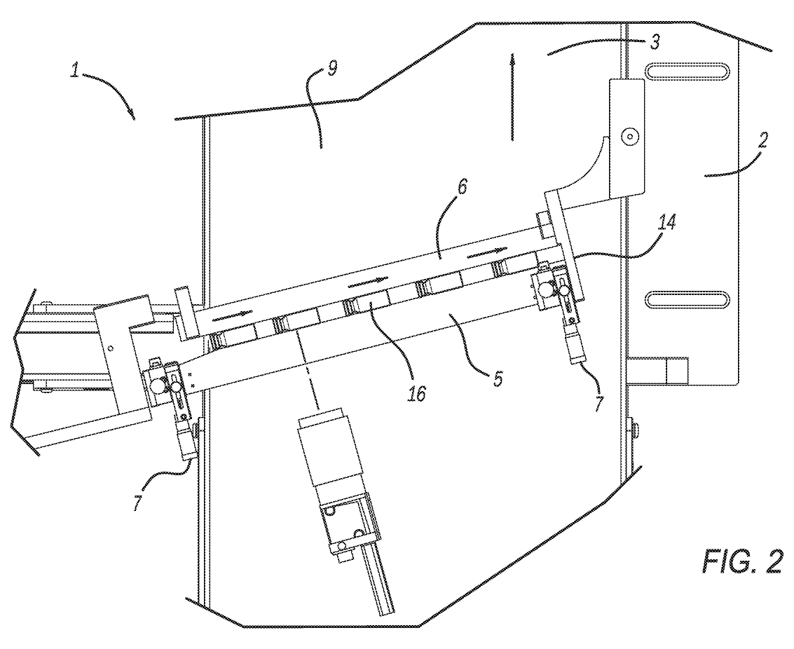

FIG. 2 is a top view of the inspection system in accordance with the present invention;

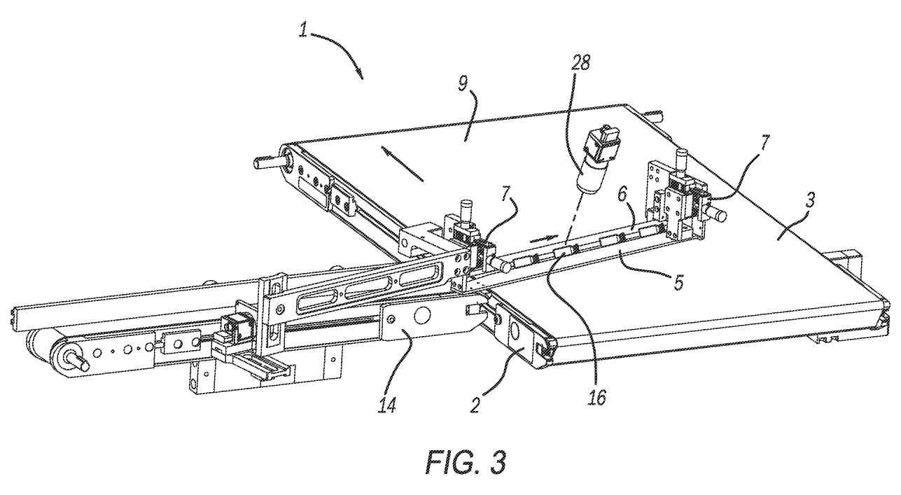

FIG. 3 is a left isometric view of the inspection system;

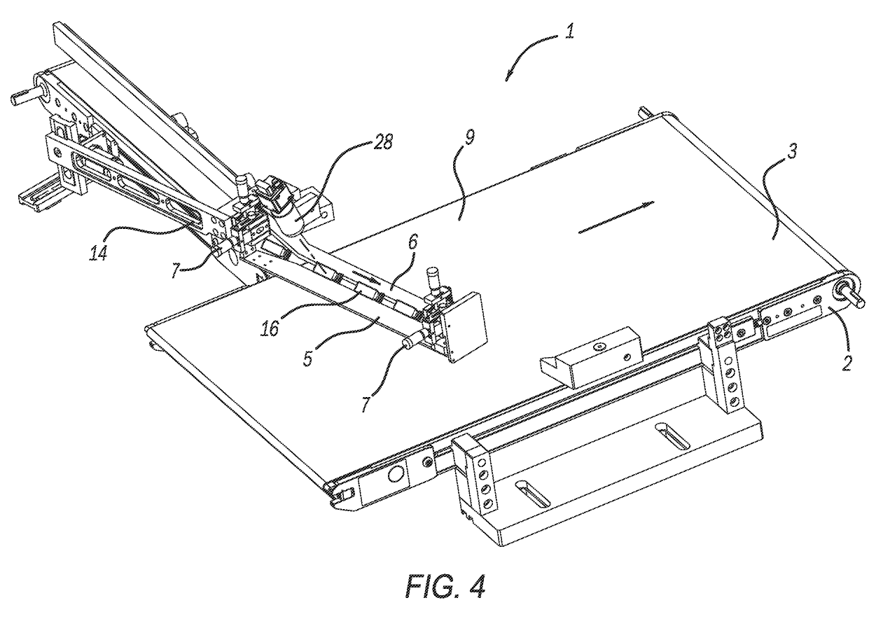

FIG. 4 is a right isometric view of the inspection system;

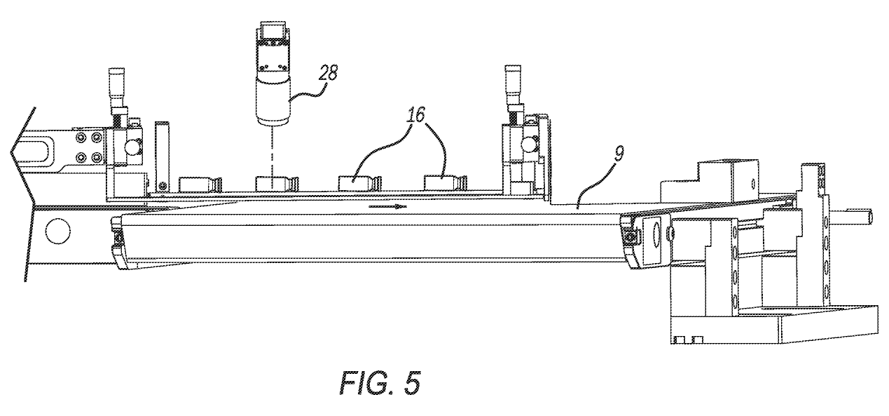

FIG. 5 is a side view of the inspection system;

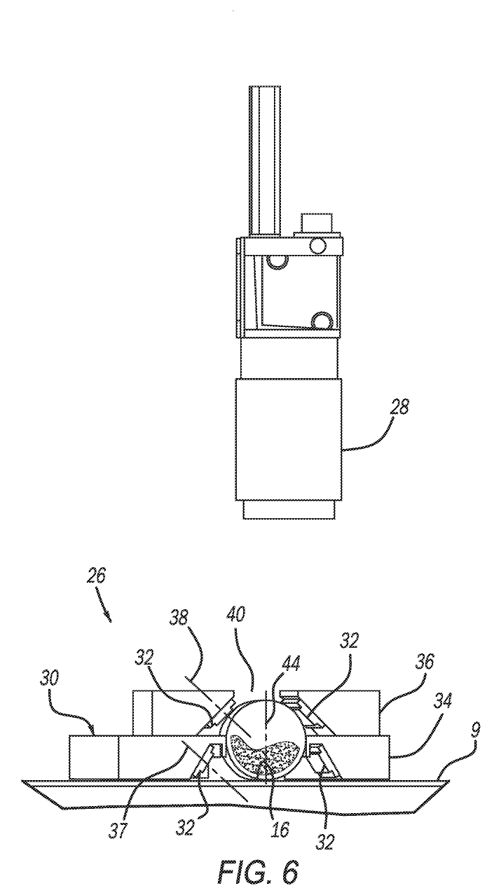

FIG. 6 is a side view showing a cross-section through a pharmaceutical vial passing through an inspection station showing illumination and camera detection features.

### DETAILED DESCRIPTION

With particular reference to FIGS. 2-6, a parts inspection system in accordance with the present invention is illustrated which is generally designated by reference number 1. As illustrated, inspection system 1 (See FIG. 6) is used, in one described application, for the inspection of pharmaceutical vials 16 having the configuration illustrated although, as previously mentioned, other types of pharmaceutical vials may also be used with the system in accordance with this invention. Preferably such alternative pharmaceutical vials for inspection are rotationally symmetrical elongated parts suitable for the conveyance system described herein and having transparent side surfaces exposing the contents for optical inspection.

Referring in particular to FIGS. 2-5 vials 16 are moved along a vial flow path through an inspection station 26 of system 1 utilizing conveyor 3 in the form of a continuous ( or “endless”) belt 9 which moves in the direction of the arrows in FIGS. 2-5. Conveyor 3 moves continuously during operation of the system. Components of system 1 are supported by frame 2. Vials 16 are trapped between stop bar 6 and vial guide rail 5 and these elements are separated to allow the vials to travel along their length. As shown by the Figures, stop bar 5 and guide bar 6 form a linear flow path for vials 16 which is oriented diagonally from the direction of movement of conveyor belt 9. The combined effect of the motion of conveyor belt 9 and the restraint provided by stop bar 5 causes vials 16 which are introduced at the left-hand end of the system (near one side edge of conveyor belt 9) as illustrated in FIG. 2 to move from the entrance end toward escapement fence 14 (near an opposite side edge of conveyor belt 9) and they are simultaneously rotated as they move linearly. The spacing between stop bar 5 and vial guide rail 6 is adjustable by a pair of guide rail adjusters 7 which enable precise variation in the spacing as well as the horizontal and vertical positioning of these elements.

Vial 16 as illustrated in FIGS. 1A and 1B is an example of a type which can be inspected in accordance with the present invention. Example vial 16 has an elongated hollow cylindrical body 18 having a closed end 19 and a necked down dispensing end 20 which may be threaded or rimmed to provide for the attachment and detachment of closure cap 21. Vials 16 are rotationally symmetric with respect to longitudinal axis 46. In FIG. 1A, a liquid material 22 is contained within vial body 18 and, in this example, liquid 22 may have entrained contaminants 23 which could be in the form of, for example; solid objects having a different composition than the liquid, gas bubbles, or phase separated solids having the same composition as the liquid. In this example, particles 23 may become concentrated within the volume of body 18, such as collecting at near one of the two ends 19 or 20 or along an inside surface of the vial body due to density variations, or in other regions of the liquid volume. FIG. 1B shows vial 16 partially filled with a powder material 24 which may have intermixed impurities which can be optically detected.

A significant feature of the present invention is the rotational movement of the vials 16 as they move linearly transiting along bar 5 and guard rail 6. With vials 16 oriented on their side, i.e. longitudinal axis 46 is generally aligned (within 20 degrees and preferably within 5 degrees) with a horizontal plane (with respect to gravity) the rotational motion will cause contaminants 23 to become agitated within the liquid or powder volume. Thus the system operates essentially as a mixer for the contents of vial 16. The agitation causes contaminants 23 to become more uniformly distributed within the volume of the liquid of vials 16. This enables the contaminants to be more readily detected during inspection. In a similar manner, contaminants 23 within a vial containing a powder mixture are also agitated and thus any contaminants become more equally distributed for detection.

With particular reference to FIG. 6, inspection station 26 is illustrated and is composed of two primary components; camera 28 and illuminator 30. Camera 28 is suspended over inspection station 26 for capturing images of vials 16 as they pass through the inspection station. For clarity, illuminator 30 is not shown in FIGS. 2-5. However, camera 28 is shown in those Figures. Illuminator 30 has groups of linear LED element arrays 32. As shown best by FIG. 6, illuminator 30 has a lower set 34 of linear arrays 32 which are aimed in a downward diagonal direction along axis 37 into a lower portion of the cross-section of vial 16, oriented about 45 degrees from the plane of the conveyor (or level with gravity). Upper set 36 of LED linear arrays 32 is positioned in the upper portion of the cross-section of vial 16 above a diametric center plane of the vials. Likewise, the linear arrays of upper set 36 are also oriented in a downward diagonal direction along axis 38 (also at about 45 degrees) into the upper portion of the vials 16. Upper array set 36 forms inspection gap 40 which forms a window or aperture for camera 28 to capture images. Both upper and lower sets of arrays include left hand and right hand elements which are oriented symmetrically with respect to a vertical diametric plane 44 through vials 16.

As vials 16 transit along stop bar 5 they are rotating before entering into the region of inspection station 26. The rotational motion, as mentioned previously, causes agitation of the material within the vials. It is desirable that such rotational agitation movement occurs before the vials enter into inspection station 26 and continues while the vial is in the inspection station for a time sufficient to generate complete images; namely, at least one full rotation.

Video camera 28 is oriented as shown in the Figures and observes the lines of laser light projecting onto vial 16 by arrays 32. Arrays 32 project light into the interior of vials 16 and illuminate the contents of the vials. Due to the transparent or semitransparent nature of the walls of vials 16 and the liquid or powder contained within the vials, some of the light is reflected by the liquid or powder, the contaminants, and the walls of the vial container and further light is reflected off of conveyor belt 9 and back through the interior of vials 16.

Images from camera 28 are processed through a processing unit or computer having digital image processing software which enables the detection of defects mentioned previously. Various techniques for the processing of the video images from video camera 28 may be employed. For example various machine learning systems based on neural network processing and artificial intelligence techniques may be used. One example is described by applicants US Patent No. 12,056,866 B2 which is hereby incorporated by reference in its entirety.

When pharmaceutical vial 16 enters the field of view of camera 28, it begins capturing images at a high frame rate. The frame rate is limited by the image resolution, which must be high enough to resolve defects for detection. Each of the vials 16 must remain within the field of view of camera 28 long enough to capture images of all sides of the vial (i.e. at least one full revolution). The resulting image series is filtered, corrected, and aggregated together, and used to generate several statistical models of the part. These different models reflect different types of image features.

During initial setup, a collection of pre-inspected acceptable vials are fed through the system 1. This set of sample vials must include samples of any manufacturing defects which are deemed acceptable. The resulting models from these acceptable vial fills are used to generate a "master" model, which reflects the unique aspects of an acceptable vial fill. During normal operation, incoming vials are compared to this master model, and any vials which exceed a user-specified margin of error are directed to a reject-parts bin. A gating system can be used to create a stream of inspected vials which meet inspection criteria and those which fail to meet inspection criteria. Such gating systems are well known in the field of the present invention and are not described here in detail.

This invention also encompasses a method of inspecting pharmaceutical vials 16 including providing mechanisms for causing the linear and rotational motion of the vial as it passes through inspection station 26, and thereafter analyzing images captured by camera 28.

Variations of inspection stations within the scope of the present invention can be envisioned. For example, various types of illumination and detection systems could be employed for evaluating the contents of vial 16. Simultaneous linear and rotational motion of vials 16 is described, as this is a desirable mechanism for moving the vials through the inspection station. However, a primary feature of the present invention is the rotational agitation movement before and during inspection which does not necessarily have to be accompanied by simultaneous linear displacement of the vials.

While the above description constitutes the preferred embodiment of the present invention, it will be appreciated that the invention is susceptible to modification, variation and change without departing from the proper scope and fair meaning of the accompanying claims.

1. A parts inspection system for an elongated pharmaceutical vial containing a liquid or a powder comprising; a conveyor causing the pharmaceutical vial oriented with a longitudinal axis of the vial in a generally horizontal position to undergo rotational motion and causing the vial to move along a vial flow path and into an inspection station, the rotational motion of the vial imparted by the conveyor causing impurities within the liquid or the powder contained within the vial to become agitated within the volume of the vial, a light source illuminating the vial as the vial passes into the inspection station, and a video camera oriented to detect an image of reflections of light from the light source as the vial is rotated in the inspection station.

2. The parts inspection system of claim 1, further comprising the conveyor in the form of an endless belt moving along a conveyor path and a stop bar oriented above the conveyor belt and oriented at a diagonal angle to the conveyor path whereby the vial introduced at near one side edge of the belt is caused to bear against the stop bar and to undergo linear motion simultaneous with the rotational motion while moving from the one side edge toward an opposite side edge of the belt.

3. The parts inspection system of claim 2, further comprising a guard rail positioned parallel to the stop bar and defining a gap therebetween through which the vial transits during the linear and rotational motion.

4. The parts inspection system of claim 2, further comprising the light source and the video camera are positioned between the conveyor one side edge and the opposite side edge.

5. The parts inspection system of claim 1, further comprising the light source in the form of a plurality of light sources including a linear array arranged along a line parallel to the vial flow path.

6. The parts inspection system of claim 5, further comprising the plurality of light sources oriented along an optical projection axis diagonal to the conveyor and arranged to project light into the vial and reflecting from the conveyor belt.

7. The parts inspection system of claim 5, further comprising the plurality of light sources including a first linear array formed by a plurality of discrete light emitting elements extending along the vial flow path spaced radially from the vial flow path and aligned with the vial path, and a second linear array formed by a plurality of discrete light emitting elements extending along the vial flow path spaced radially from the vial flow path and aligned with the vial path, the first and the second linear arrays oriented to present light directed to the vials at the different angular positions relative to the vial path.

8. The parts inspection system of claim 7, further comprising the plurality of light sources oriented along an optical projection axis diagonal to the conveyor and arranged to project light into the vial and reflecting from the conveyor belt.

9. The parts inspection system of claim 7, further comprising the first and second arrays each presenting a line of light oriented toward the vial.

10. A parts inspection system for an elongated pharmaceutical vial containing a liquid or a powder comprising; a conveyor causing the vial oriented with a longitudinal axis of the vial in a generally horizontal position to undergo linear motion and rotational motion along a vial path, the conveyor in the form of an endless belt moving along a conveyor path and a stop bar oriented above the conveyor belt and oriented at an angle to the conveyor path whereby the vial introduced at near one side edge of the belt is caused to bear against the stop bar and undergo the linear and rotational motion from the one side edge to an opposite side edge of the belt, a first plurality of light sources presenting sources of light illuminating the vial parallel to a radial orientation with respect to the central axis of the vial path on one side of the vial as the vial undergoes the linear and rotational motion, the first plurality of light sources including a first linear array formed by a plurality of discrete light emitting elements oriented to extend along the vial path and aligned with the vial path on one side of the vial flow path, and a second linear array formed by a plurality of discrete light emitting elements extending along the vial path aligned with the vial path on an opposite side of the vial flow path, and a video camera oriented to detect an image of the reflections of light from the first and second linear arrays of light sources from the vial.

11. The parts inspection system of claim 10, further comprising, a second plurality of light sources presenting sources of light illuminating the vial parallel to a radial orientation with respect to the central axis of the vial path on one side of the vial as the vial undergoes the linear and rotational motion, the second plurality of light sources including a third linear array formed by a plurality of discrete light emitting elements oriented to extend along the vial path and aligned with the vial path on one side of the vial flow path, and a fourth linear array formed by a plurality of discrete light emitting elements extending along the vial path aligned with the vial path on an opposite side of the vial flow path, the first and second plurality of light sources oriented to present light at along spaced apart planes.

12. The parts inspection system of claim 10, further comprising a guard rail positioned parallel to the stop bar and defining a gap therebetween through which the vial transits during the linear and rotational motion.

13. The parts inspection system of claim 10, further comprising wherein the first plurality of light sources is formed by individual LED elements.

14. A method for inspecting an elongated pharmaceutical vial containing a liquid or a powder or comprising the steps of; providing a conveyor for causing the vial oriented with a longitudinal axis of the vials in a generally horizontal position to undergo rotational motion, moving the vial along a vial flow path and into an inspection station, the rotational motion of the vial imparted by the conveyor causing impurities within the liquid or the powder contained within the vial to become agitated within the volume of the vial, providing a light source, the light source illuminating the vial as the vial passes into the inspection station, and providing a video camera oriented to detect an image of reflections of light from the light source from the vial as the vial is present in the inspection station.

15. A method for inspecting an elongated pharmaceutical vial in accordance with claim 14, further comprising the step of; providing the conveyor for causing the vial to undergo linear motion simultaneous with the rotational motion along the vial flow path and through the inspection station.

16. A method for inspecting an elongated pharmaceutical vial in accordance with claim 14, further comprising the step of providing a plurality of the light sources for illuminating the vial as the vial passes through the inspection station.

17. A method for inspecting an elongated pharmaceutical vial in accordance with claim 14, further comprising the step of; causing the vial to remain in the inspection station for at least one full revolution of the rotational movement.
